(19) United States
(12) Patent Application Publication
(10) Pub. No.: US 2023/0247998 A1
(43) Pub. Date: Aug. 10, 2023

(54) STABLE CYMOXANIL FORMULATIONS

(71) Applicant: Adama Makhteshim Ltd., Beer Sheva (IL)

(72) Inventors: Diana POLIAK, Beer-Sheva (IL); Viacheslav FIRER, Beer-Sheva (IL)

(73) Assignee: Adama Makhteshim Ltd., Beer Sheva (IL)

(21) Appl. No.: 18/009,082

(22) PCT Filed: Jun. 3, 2021
(86) PCT No.: PCT/IL2021/050662

§ 371 Date: Dec. 8, 2022

Related U.S. Application Data
(60) Provisional application No. 63/035,960, filed on Jun. 8, 2020.

(51) Int. Cl. A01N 47/34; A01P 3/00; A01N 25/04; A01N 43/40

(52) U.S. Cl. CPC A01N 47/34; A01P 3/00; A01N 25/04; A01N 43/40

(57) ABSTRACT

The present invention relates to a suspension concentrate (SC) composition comprising a) cymoxanil and b) a buffering system; wherein the buffering system has an effective pH range of 2-5. Optionally, the composition further comprises at least one additional pesticide, at least one agriculturally acceptable carrier and/or additives.

### FIELD OF THE INVENTION

The present invention relates to suspension concentrate formulations of cymoxanil, as well as methods of producing suspension concentrate formulations of cymoxanil.

### BACKGROUND OF THE INVENTION

Fungal infestations cause significant yield reduction, preventing and treating fungal infestations of plants and plant parts is crucial to obtain high productivity and is a continual objective in the agricultural field.

Cymoxanil, having the chemical name 1-(2-cyano-2-methoxyiminoacetyl)-3-ethylurea, disclosed in U.S. Pat. No. 3,957,847; has the following structural formula (I):

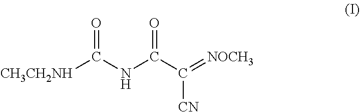

Cymoxanil is a cyanoacetamide compound, locally systemic, used as both a curative and preventative foliar fungicide. Cymoxanil is used extensively in combination with other fungicides to control of Oomycetes such as Pseudoperonospora spp. Peronospora spp, Phytophthora spp, and Plasmopara sp of grapes, potatoes, fruit trees, ornamentals and vegetables. It has contact and local systemic activity and in the target pathogen, cymoxanil inhibits synthesis of nucleic acids, amino acids, and other cellular processes.

As stated in the J. Agric. Food Chem 2004, 52 99-104, Cymoxanil is highly soluble in water and considered quite volatile, thus making it a challenge to create a stable liquid formulation. In particular, cymoxanil has a hydrolysis half-life of 148 days at pH=5; 34 hours at pH=7; and 31 minutes at pH=9. Indicating that the stability of cymoxanil is dependent on the surrounding pH.

EP 1077029 relates to an oil in water pesticide formulation comprising an ethylene bisdithiocarbamate fungicide and cymoxanil. The patent application proposes using a buffer comprising an oil soluble acid and a water soluble acid in order to stabilize the formulation.

Cymoxanil is typically provided as dry solid formulations, for example, as water dispersible granules and wettable powders, partly because cymoxanil is known to be unstable and quickly degraded in the presence of water. Further, cymoxanil has a relatively high solubility in water and therefore tends to undergo crystalline growth in aqueous solution. Therefore, generally one can mostly find in the market today dry formulations (e.g. granules and powders) comprising cymoxanil or combinations of cymoxanil with other fungicides.

However, there is a need to provide a liquid formulation because of the ease of use and to avoid the inconvenience associated with manipulating powders. Liquid formulations have the advantage over powder formulations that upon dilution, typically by adding water, they do not produce dust. The particle size of the active ingredients are smaller in liquid formulations as compared to powder formulations.

Further, it is desirable to obtain fungicidal suspension concentrates comprising as much active ingredient as possible. However, the amount of concentration is limited by the requirement to obtain a stable product. Stable formulations may be defined such that the solid particulates therein do not settle and they can be stored over extended periods of time.

Therefore, there is a need in the art for aqueous-based cymoxanil formulations that exhibit improved properties, including, for example, improved stability in water.

### SUMMARY OF THE INVENTION

The present invention provides a stable suspension concentrate (SC) composition comprising: a) cymoxanil; b) a buffering system; c) optionally at least one additional pesticide; d) optionally an agriculturally acceptable carrier; wherein the buffering system has an effective pH range of 2-5.

The present invention provides a process for preparing a stable suspension concentrate composition comprising: a) obtaining an amount of cymoxanil and a buffering system; b) milling the cymoxanil and the buffering system at a temperature of at most 25° C.; wherein the buffering system has an effective pH range of 2-5.

The present invention provides a stable suspension concentrate (SC) composition prepared according to a process for preparing a stable suspension concentrate composition comprising: a) obtaining an amount of cymoxanil and a buffering system; b) milling the cymoxanil and the buffering system at a temperature of at most 25° C.; wherein the buffering system has an effective pH range of 2-5.

The present invention provides a method of controlling and/or preventing pests comprising applying an effective amount of the SC composition as described herein to a locus where the pest is to be controlled and/or prevented so as to thereby control and/or prevent the pest.

The present invention provides a use of the SC composition as described herein, for controlling and/or preventing pests.

The present invention provides a method of treating a locus against pest infestation comprising applying an effective amount of any one of the composition described herein to the locus so as to thereby treat the locus against pest infestation.

The present invention provides a method for treating a plant or a plant material against pest infestation comprising applying an effective amount of any one of the composition described herein to the plant, the plant material, or the vicinity of the plant or plant material so as to thereby treat the plant or plant material against pest infestation.

The present invention provides a method for controlling and/or preventing of fungal attack on soil, plant, tuber, fruit, root, foliage, seed, locus of the fungus, or a locus where fungal infestation is to be prevented, wherein the method comprises applying a fungicidally effective amount of any one of the composition described herein to the soil, plant, roots, foliage, seed, locus of the fungus, or locus in which the infestation is to be prevented so as to thereby control and/or prevent fungal attack.

### DETAILED DESCRIPTION OF THE INVENTION

Aqueous based formulations such as suspension concentrates (SC) are convenient to use as they may be applied after dilution with water. SC compositions of cymoxanil are challenging to formulate because cymoxanil is not stable in an aqueous environments and readily degrades and is chemically sensitive at neutral or basic pH. A further challenge is the crystal growth of cymoxanil in the aqueous environment.

A novel suspension concentrate composition of cymoxanil is described herein. This novel suspension concentrate composition comprises cymoxanil and a buffering system. Without wishing to be bound by any theory, it is hypothesized that the narrow effective pH range of the claimed buffering systems are similar to the pH range in which cymoxanil is stable. This provides a stable suspension concentrate composition comprising cymoxanil.

### Definitions

Unless defined otherwise, all technical and scientific terms used herein have the meaning commonly understood by persons of ordinary skill in the art to which this subject matter pertains.

As used herein, the term “composition” includes a mixture or mixtures of cymoxanil with another component, such as a buffering system. In some embodiments, the composition may comprise at least one additional pesticide.

As used herein, the term “suspension concentrate composition” or “SC composition” refers to a composition also sometimes referred to as an “aqueous flowable” composition, which compositions are known in the art and include or consist of particles of a generally insoluble solid active fungicide compound in suspension (preferably concentrated suspension) in water.

As used herein, the term “agriculturally acceptable carrier” refers to a solvent which is known and accepted in the art for the formation of compositions for agricultural or horticultural use.

As used herein, the term “additive” refers to any substance that itself is not an active ingredient but is added to the composition. Examples of additives includes, but are not limited to, adjuvants, surfactants, emulsifiers, anti-freeze agents, antifoam agents, and preservatives.

As used herein, the term “stable” when used in connection with a composition means that the composition is physically stable and chemically stable. As used herein, the term “chemically stable” means that no significant decomposition of the active components was observed after at least 2 weeks of storage in a sealed package at a temperature of 54° C. As used herein, the term “physically stable” means that no significant sedimentation was observed after at least 2 weeks of storage in a sealed package at a temperature of 54° C. “Physically stable” may also refer to other parameters such as viscosity, density etc. which are a function of the the ability of the suspension to remain in its original state.

Stability may be assessed according to test protocol established by the Collaborative International Pesticides Analytical Council Ltd. (CIPAC). Stability can be assessed under normal storage conditions which is after two years storage at room temperature. Stability can also be assessed under accelerated storage conditions which is after 2 weeks storage at 54° C. or after 8 weeks at 40° C. or after 12 weeks at 35° C. or after 2 weeks at 0° C. or after 2 weeks at −10° C.

Particle size is typically defined as a log-normal distribution with a median diameter or D90—that is 90% of the particles measured are less than the given value and 10% are greater than the given value. The term “particle size distribution” as used herein refers to the relative percentages by weight or volume of each of the different size fractions of a particulate matter. The term “D90”, as used herein refers to the 90% quantile of a particle size distribution. The term “D90” hence defines a size where 90 volume percent of the particles have sizes less than the value given.

The particle size distributions for the present application can be measured using laser light diffraction equipment or other types of equipment that are also suitable for particle size distribution determinations.

As used herein, the term “mixture” refers, but is not limited, to a combination in any physical form, e.g., blend, solution, alloy, or the like.

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

As used herein, the term “contemporaneous” when used in connection with application of agrochemicals means that an individual agrochemical is applied separately from another agrochemical or premixture at the same time or at times sufficiently close together such that at least one benefit from combining the agrochemicals is achieved, for example, if two active components are applied contemporaneously, an activity that is additive or more than additive or synergistic relative to the activity of either active component alone at the same dose is achieved.

As used herein, the term “tank mix” means one or more of the components of the composition of the present invention are mixed in a spray tank at the time of spray application or prior to spray application.

As used herein, the term “effective” when used in connection with an amount of the combination, mixture or composition refers to an amount of the combination, mixture or composition that achieve an agriculturally beneficial level of control and/or prevention of the pest when applied to the locus where the pest is to be controlled and/or prevented.

As used herein, the term “effective amount” refers to an amount of the active component that is commercially recommended for use to control and/or prevent pest.

The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “more effective for controlling pest” includes, but is not limited to, increasing efficacy of controlling pest and reducing the amount of time needed to achieve a given level of pest control.

As used herein, the term “more effective for preventing pest” includes, but is not limited to, increasing efficacy of preventing pest infestation and prolonging the duration of protection against pest infestation after application.

As used herein, the term “pest” includes, but is not limited to, unwanted fungus, unwanted insect, unwanted nematode, and unwanted weeds.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “locus” includes not only areas where the pest may already be developed, but also areas where pest have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. The term “plant” also includes the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

The term “a” or “an” as used herein includes the singular and the plural, unless specifically stated otherwise. Therefore, the terms “a,” “an,” or “at least one” is used interchangeably in this application.

Throughout the application, descriptions of various embodiments are described using the term “comprising”; however, it will be understood by one of skill in the art, that in some specific instances, an embodiment can be described using the language “consisting essentially of” or “consisting of.”

The term “about” herein specifically includes ±10% from the indicated values in the range. In addition, the endpoints of all ranges directed to the same component or property herein are inclusive of the endpoints, are independently combinable, and include all intermediate points and ranges.

It is understood that where a parameter range is provided, all integers within that range, and tenths thereof, are also provided by the invention as if the integers and tenths thereof are expressly described herein. For example, “0.1% to 70%” includes 0.1%, 0.2%, 0.3%, 0.4%, 0.5% etc. up to 70%.

All publications, patents and patent applications mentioned in this specification are herein incorporated in their entirety by reference into the specification, to the same extent as if each individual publication, patent or patent application was specifically and individually indicated to be incorporated herein by reference.

The following examples illustrate the practice of the present subject matter in some of its embodiments but should not be construed as limiting the scope of the present subject matter. Other embodiments apparent to persons of ordinary skill in the art from consideration of the specification and examples herein that fall within the spirit and scope of the appended claims are part of this invention. The specification, including the examples, is intended to be exemplary only, without limiting the scope and spirit of the invention.

Aspects and embodiments of the present invention will now be described.

The present invention provides a suspension concentrate composition comprising (a) cymoxanil and (ii) a buffering system, wherein the buffering system has an effective pH range of 2-5.

In some embodiments, the suspension concentrate composition is stable. In some embodiments, the suspension concentrate composition has low persistent foam.

In some embodiments, the buffering system is a conjugate acid-base pair having an effective pH range of 2-5 selected from the group comprising acetic acid/sodium acetate and formic acid/potassium formate.

In one embodiment, the present invention provides a suspension concentrate composition comprising (a) cymoxanil and (ii) a buffering system, wherein the buffering system is a conjugate acid-base pair selected from the group comprising acetic acid/sodium acetate.

In some embodiments, the amount of cymoxanil in the suspension concentrate (SC) composition is from about 0.1% to about 80% by weight, based on the total weight on the composition. In some embodiments, the amount of cymoxanil in the SC composition is from about 0.1% to about 50% by weight, based on the total weight on the composition. In some embodiments, the amount of cymoxanil in the SC composition is from about 10% to about 40% by weight, based on the total weight on the composition. In some embodiments, the amount of cymoxanil in the SC composition is from about 10% to about 40% by weight, based on the total weight on the composition. In some embodiments, the amount of cymoxanil in the SC composition is from about 18% to about 25% by weight, based on the total weight on the composition. In some embodiments, the amount of cymoxanil in the SC composition is about 20% by weight, based on the total weight on the composition. In some embodiments, the amount of cymoxanil in the SC composition is about 22% by weight, based on the total weight on the composition. In some embodiments, the amount of cymoxanil in the SC composition is 23% by weight, based on the total weight on the composition. In some embodiments, the amount of cymoxanil in the SC composition is from about 40% to about 80% by weight, based on the total weight on the composition. In some embodiments, the amount of cymoxanil in the SC composition is from about 50% to about 75% by weight, based on the total weight on the composition.

In some embodiments, the amount of cymoxanil in the SC composition is at least 10% by weight based on the total weight of the composition. In some embodiments, the amount of cymoxanil in the SC composition is at least 20% by weight based on the total weight of the composition. In some embodiments, the amount of cymoxanil in the SC composition is at least 25% by weight based on the total weight of the composition. In some embodiments, the SC composition is a high load composition.

In some embodiments, the amount of the buffering system in the suspension concentrate composition is from about 0.1% to about 25% by weight, based on the total weight on the composition. In some embodiments, the amount of the buffering system in the suspension concentrate composition is from about 0.1% to about 10% by weight, based on the total weight on the composition. In some embodiments, the amount of the buffering system in the suspension concentrate composition is from about 0.1% to about 5% by weight, based on the total weight on the composition. In some embodiments, the amount of the buffering system in the suspension concentrate composition is from about 0.5% to about 2% by weight, based on the total weight on the composition. In some embodiments, the amount of the buffering system in the suspension concentrate composition is from about 0.1% to about 2% by weight, based on the total weight on the composition. In some embodiments, the amount of the buffering system in the suspension concentrate composition is about 1% by weight, based on the total weight on the composition. In some embodiments, the amount of the buffering system in the suspension concentrate composition is about 2% by weight, based on the total weight on the composition.

In some embodiments, the ratio between the buffering system and the cymoxanil is at least 1:1. In some embodiments, the ratio between the buffering system and the cymoxanil is at least 1:2. In some embodiments, the ratio between the buffering system and the cymoxanil is at least 1:5. In some embodiments, the ratio between the buffering system and the cymoxanil is at least 1:10. In some embodiments, the ratio between the buffering system and the cymoxanil is at least 1:15. In some embodiments, the ratio between the buffering system and the cymoxanil is at least 1:20. In some embodiments, the ratio between the buffering system and the cymoxanil is at least 1:25. In some embodiments, the ratio between the buffering system and the cymoxanil is at least 1:30. In some embodiments, the ratio between the buffering system and the cymoxanil is at least 1:40. In some embodiments, the ratio between the buffering system and the cymoxanil is at least 1:50. In some embodiments, the ratio between the buffering system and the cymoxanil is at least 1:21.

In some embodiments, the amount of the agriculturally acceptable carrier in the suspension concentrate composition is from about 0.1% to about 90% by weight, based on the total weight on the composition. In some embodiments, the amount of the agriculturally acceptable carrier in the suspension concentrate composition is from about 20% to about 80% by weight, based on the total weight on the composition. In some embodiments, the amount of the agriculturally acceptable carrier in the suspension concentrate composition is from about 30% to about 60% by weight, based on the total weight on the composition. In some embodiments, the amount of the agriculturally acceptable carrier in the suspension concentrate composition is from about 40% to about 50% by weight, based on the total weight on the composition. In some embodiments, the amount of the agriculturally acceptable carrier in the suspension concentrate composition is from about 45% to about 55% by weight, based on the total weight on the composition. In some embodiments, the amount of the agriculturally acceptable carrier in the suspension concentrate composition is about 48% by weight, based on the total weight on the composition.

In some embodiments, the suspension concentrate composition comprises an amount of at least one additive.

In some embodiments, the additive is selected from the group consisting of adjuvants, surfactants, emulsifiers, anti-freeze agents, antifoam agents, preservatives, and any combination thereof. Other ingredients, such as dispersing agents, wetting agents, adhesives, neutralizers, thickeners, binders, sequestrants, stabilizers, solubilizer, salts, and/or fertilizers, may also be added to the disclosed compositions.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

In some embodiments, the additive is a dispersant. In some embodiments, the dispersant is ethylene oxide/propylene oxide block copolymers. In some embodiments, the dispersant is a methyl ether methacrylate copolymer. In some embodiments, the dispersant is polysorbate 20.

In some embodiments, the additive is a wetter. In some embodiments, the wetter is a polyalkyleneoxide modified heptamethyltrisiloxane.

In some embodiments, the amount of additive(s) in the suspension concentrate composition is from about 1% to about 80% by weight, based on the total weight of the composition. In some embodiments, the amount of additive(s) in the suspension concentrate composition is from about 1% to about 50% by weight, based on the total weight of the composition. In some embodiments, the amount of additive(s) in the suspension concentrate composition is from about 1% to about 30% by weight, based on the total weight of the composition. In some embodiments, the amount of additive(s) in the suspension concentrate composition is from about 1% to about 20% by weight, based on the total weight of the composition. In some embodiments, the amount of additive(s) in the suspension concentrate composition is from about 10% to about 20% by weight, based on the total weight of the composition. In some embodiments, the amount of additive(s) in the suspension concentrate composition is from about 10% to about 15% by weight, based on the total weight of the composition. In some embodiments, the amount of additive(s) in the suspension concentrate composition is about 12% by weight, based on the total weight of the composition.

In some embodiments, the amount of dispersant in the suspension concentrate composition is from about 1% to about 20% by weight, based on the total weight of the composition. In some embodiments, the amount of dispersant in the suspension concentrate composition is from about 1% to about 10% by weight, based on the total weight of the composition. In some embodiments, the amount of dispersant in the suspension concentrate composition is about 8% by weight, based on the total weight of the composition.

In some embodiments, the amount of wetter in the suspension concentrate composition is from about 0.1% to about 10% by weight, based on the total weight of the composition. In some embodiments, the amount of wetter in the suspension concentrate composition is from about 0.1% to about 5% by weight, based on the total weight of the composition. In some embodiments, the amount of wetter in the suspension concentrate composition is about 0.5% by weight, based on the total weight of the composition.

The term “antifoam agent” refers to mean a substance that is used to reduce foaming. Foaming may result from the presence of foam-inducing agents. The presence of foam is generally undesirable because foam may interfere with processing.

Antifoam agents may include but are not limited to silicone-based defoamers, such as linear polydimethylsiloxanes which contain a compound of the formula HO—[Si(CH3)2-O—]ₙ—H, in which the end groups are modified, by etherification for example, or are attached to the groups —Si(CH3)₃, or hydroxyl terminated.

In some embodiments, the amount of the antifoam in the suspension concentrate composition is from about 0.1% to about 20% by weight, based on the total weight of the composition. In some embodiments, the amount of the antifoam in the suspension concentrate composition is from about 5% to about 20% by weight, based on the total weight of the composition. In some embodiments, the amount of the antifoam in the suspension concentrate composition is from about 5% to about 15% by weight, based on the total weight of the composition. In some embodiments, the amount of the antifoam in the suspension concentrate composition is from about 10% by weight, based on the total weight of the composition.

In some embodiments, the suspension concentrate composition comprises an amount of at least one additional pesticide.

In some embodiments, the additional pesticide is a fungicide. In some embodiments, the fungicide is selected from the group comprising of fluopicolide, fluopyram, fluopimomide, tioxymid, trichlamide, zarilamid and zoxamide. In a specific example, the additional pesticide is fluopicolide.

In some embodiments, the amount of the additional pesticide in the suspension concentrate composition is from about 1% to about 80% by weight, based on the total weight of the composition. In some embodiments, the amount of the additional pesticide in the suspension concentrate composition is from about 10% to about 50% by weight, based on the total weight of the composition. In some embodiments, the amount of the additional pesticide in the suspension concentrate composition is about 10% to about 50% by weight, based on the total weight of the composition. In some embodiments, the amount of the additional pesticide in the suspension concentrate composition is about 20% by weight, based on the total weight of the composition. In some embodiments, the amount of the additional pesticide in the suspension concentrate composition is about 18.5% by weight, based on the total weight of the composition.

In some embodiments, the composition comprising the additional pesticide is more effective for controlling and/or preventing pest than when each pesticide at the same amount is applied alone.

In some embodiments, the amount of cymoxanil and the amount of the additional pesticide(s) in the composition when applied together is more effective for controlling and/or preventing pest than when each pesticide at the same amount is applied alone.

In some embodiments, the amount of cymoxanil in the composition is less than the pesticidally effective amount of cymoxanil when cymoxanil is used alone. In some embodiments, the amount of the additional pesticide(s) in the composition is less than the pesticidally effective amount of the additional pesticide(s) when the additional pesticide(s) is used alone.

In some embodiments, the cymoxanil and the additional pesticide are synergistic. Synergism occurs when the effect of two or more compounds exceeds the effect of the compounds when used alone.

As will be readily appreciated, any material to which the disclosed compositions can be added may be used, provided they yield the desired utility without significant interference with the activity of these compositions, including synergistic compositions, as fungicidal agents.

The disclosed compositions may optionally include combinations that can comprise at least 1% by weight of one or more of the compositions with another pesticidal compound. Such additional pesticidal compounds may be herbicides, fungicides, insecticides, nematocides, miticides, arthropodicides, bactericides or combinations thereof that are compatible with the synergistic compositions of the present disclosure in the medium selected for application, and not antagonistic to the activity of the present compounds. Accordingly, in such embodiments the other pesticidal compound is employed as a supplemental toxicant for the same or for a different pesticidal use. The pesticidal compound and the synergistic composition can generally be mixed together in a weight ratio of from 1:100 to 100:1.

According to an embodiment, the suspension concentrate composition comprises about 20-25% by weight of cymoxanil, based on the total weight of the composition, about 10-20% by weight of fluopicolide, based on the total weight of the composition, about 1-5% by weight of the buffering system, based on the total weight of the composition, about 10-15% by weight of additives, based on the total weight of the composition, and about 40-50% by weight of an agriculturally acceptable carrier, based on the total weight of the composition.

According to an embodiment, the suspension concentrate composition comprises about 21% by weight of cymoxanil, based on the total weight of the composition, about 18% by weight of fluopicolide, based on the total weight of the composition, about 1% by weight of the buffering system, based on the total weight of the composition, about 12% by weight of additives, based on the total weight of the composition, and about 48% by weight of an agriculturally acceptable carrier, based on the total weight of the composition.

The present invention also provides a method of controlling and/or preventing pests comprising applying an effective amount of the suspension concentrate compositions, disclosed herein, to a locus where the pest is to be controlled and/or prevented so as to thereby control and/or prevent the pest.

In some embodiments, the pest is a fungus.

In some embodiments, the locus where the pest is to be controlled and/or prevented is a crop field.

The present invention also provides a method for controlling fungi comprising applying an effective amount of the suspension concentrate compositions disclosed herein, to a locus where the fungi is to be controlled so as to thereby control the fungi.

The present invention also provides a method of controlling fungi in a field of crop comprising applying an effective amount of the suspension concentrate compositions disclosed herein, to the field of crop so as to thereby control the fungi in the field of crop.

In some embodiments, the crop is selected from the group consisting of grapes, potato, cocoa, roses, palm oil vegetables from the families solanaceae (for example, tomato, pepper), cucurbitaceae (for example, cucumber, melon) brassicas (for example, cauliflower, cabbage), allioideae (for example, onion, garlic), asteraceae (for example, lettuce), soybean, sunflower, oak trees, fruit trees (for example, citrus), ornamentals (for example, impatiens).

In some embodiments, the suspension concentrate composition is diluted with water prior to application.

In some embodiments, the locus where the fungi is to be controlled is a crop field. The fungi may be from the class oomycetes selected from the group comprising Pseudoperonospora spp. Peronospora sp, Phytophthora spp, Pythium sp. and Plasmopara sp.

In some embodiments, the suspension concentrate composition is applied as pre-harvest aid.

The application rates of the combination may vary, depending on the desired effect. In an embodiment, depending on the desired effect, the suspension concentrate (SC) composition is applied at an amount from about 0.01 L/ha to about 5 L/ha. In some embodiments, the SC composition is applied at an amount from about 0.1 L/ha to about 2 L/ha. In a specific embodiment, the SC composition is applied at an amount from about 0.5-0.7 L/ha.

In some embodiments, the suspension concentrate composition is applied at an amount from about 0.1 g/ha to about 500 g/ha of cymoxanil. In some embodiments, the suspension concentrate composition is applied at an amount from about 1 g/ha to about 500 g/ha of cymoxanil. In some embodiments, the suspension concentrate composition is applied at an amount from about 10 g/ha to about 400 g/ha of cymoxanil. In some embodiments, the suspension concentrate composition is applied at an amount from about 100 g/ha to about 300 g/ha of cymoxanil. In a further embodiment, the suspension concentrate composition is applied at an amount from about 150 g/ha to about 250 g/ha of cymoxanil. In some embodiments, the suspension concentrate composition is applied at an amount of about 120-156 g/ha of cymoxanil.

In some embodiments, the method comprises applying at least one additional pesticide.

In some embodiments, the additional pesticide is a fungicide. In some embodiments, the fungicide is selected from the group comprising of fluopicolide, fluopyram, fluopimomide, tioxymid, trichlamide, zarilamid and zoxamide. In a specific example, the additional pesticide is fluopicolide.

In some embodiments, the suspension concentrate composition is applied at an amount from about 0.1 g/ha to about 500 g/ha of the additional pesticide. In some embodiments, the suspension concentrate composition is applied at an amount from about 1 g/ha to about 500 g/ha of the additional pesticide. In some embodiments, the suspension concentrate composition is applied at an amount from about 10 g/ha to about 400 g/ha of the additional pesticide. In some embodiments, the suspension concentrate composition is applied at an amount from about 100 g/ha to about 300 g/ha of the additional pesticide. In some embodiments, the suspension concentrate composition is applied at an amount from about 150 g/ha to about 250 g/ha of the additional pesticide. In some embodiments, the suspension concentrate composition is applied at an amount of about 100-140 g/ha of the additional pesticide. In a specific embodiment, the suspension concentrate composition is applied at an amount of about 100-140 g/ha of fluopicolide.

In some embodiments, the cymoxanil and the additional pesticide can be applied simultaneously, that is jointly or separately, or in succession, in sequence, in the case of separate application. The application of the two compounds jointly or separately generally does not have any effect on the result of the control measures.

That is, each of cymoxanil and the additional pesticide may be applied jointly or in succession. In one example, cymoxanil and the additional pesticide are prepared separately, and the individual formulations are applied as is, or diluted to predetermined concentrations. In a further example, cymoxanil and the additional pesticide are prepared separately, and the formulations are mixed when diluted to a predetermined concentration. In another example, cymoxanil and the additional pesticide are formulated together, and the formulation is applied as it is, or the formulation is diluted to a predetermined concentration.

For example, each of cymoxanil and fluopicolide may be applied jointly or in succession. In one example, cymoxanil and fluopicolide are prepared separately, and the individual formulations are applied as is, or diluted to predetermined concentrations. In a further example, cymoxanil and fluopicolide are prepared separately, and the formulations are mixed when diluted to a predetermined concentration. In another example, cymoxanil and fluopicolide are formulated together, and the formulation is applied as it is, or the formulation is diluted to a predetermined concentration.

The present invention also provides use of the suspension concentrate compositions disclosed herein, for controlling and/or preventing fungi comprising applying the suspension concentrate compositions disclosed herein, to a locus where the fungi is to be controlled and/or prevented.

The present invention also provides the suspension concentrate compositions disclosed herein for use in controlling fungi comprising applying an effective amount of the suspension concentrate compositions disclosed herein to a locus where the fungi is to be controlled.

In another embodiment, the present invention provides a kit comprising suspension concentrate compositions disclosed herein. Such kits may comprise, in addition to the aforementioned active components, one or more additional active and/or inactive ingredients, either within the provided composition or separately.

The subject invention also provides a process for preparing stable suspension concentrate (SC) compositions disclosed herein:
a) obtaining an amount of cymoxanil and a buffering system;
b) milling the cymoxanil and the buffering system at a temperature of at most 25° C.;
wherein the buffering system has an effective pH range of 2-5.

In some embodiments, step a) further comprises obtaining the amount of the agriculturally acceptable carrier and step b) comprises milling the cymoxanil, the buffering system and the agriculturally acceptable carrier obtained in step a) at a temperature of at most 25° C. to obtain the SC composition.

In some embodiments, step a) further comprises obtaining the amount of at least one additive and step b) comprises milling the cymoxanil, the buffering system and the at least one additive obtained in step a) at a temperature of at most 25° C. to obtain the SC composition. The additive may be selected from t a group comprising of adjuvants, surfactants, emulsifiers, antifreeze agents, an antifoam agents, solvents, co-solvents and preservatives.

In some embodiments, step b) is performed at a temperature of at most 15° C.

In some embodiments, the milling of step b) is performed until a homogeneous mixture is obtained.

In some embodiments, an antifoaming agent is added to the cymoxanil and buffering system before the milling step.

In some embodiments, an antifoaming agent is added after the milling step.

In some embodiments, an additional fungicide is added in step a).

In some embodiments, the process provides a stable SC composition in which crystal growth of cymoxanil is controlled.

In some embodiments, the process provides a stable SC composition in which minimal or no foam is produced.

In yet another embodiment, the product of any of the disclosed processes can be isolated from the reaction mixture by any conventional techniques well-known in the art. Such isolation techniques can include, without limitation, one or more of the following: concentration, extraction, precipitation, cooling, filtration, crystallization, and centrifugation, followed by drying.

In yet another embodiment, the product of any of the disclosed processes can be optionally purified by any conventional techniques well-known in the art. Such purification techniques may include, without limitation, one or more of the following: precipitation, crystallization, slurrying, washing in a suitable solvent, filtration through a packed-bed column, dissolution in an appropriate solvent, and re-precipitation by addition of a second solvent in which the compound is insoluble, or any combination thereof.

Each embodiment disclosed herein is contemplated as being applicable to each of the other disclosed embodiments. Thus, all combinations of the various elements described herein are within the scope of the invention. In addition, the elements recited in composition embodiments can be used in the combination, mixture, method, use, package and process embodiments described herein and vice versa.

This invention will be better understood by reference to the Examples which follow, but those skilled in the art will readily appreciate that the specific experiments detailed are only illustrative of the invention as described more fully in the claims which follow thereafter.

The invention is illustrated by the following examples without limiting it thereby.

### EXAMPLES

### Example 1—Fluopicolide+Cymoxanil Suspension Concentrate Composition

| Ingredient | | Concentration (gr/L) |
|---|---|---|
| Fluopicolide Tech (A.I. as 100%) | | 200 |
| CAS: 239110-15-7 | | |
| Cymoxanil tech. (A.I. as 100%) | | 240 |
| CAS: 57966-95-7 | | |
| Silwet L-77 | | 5.7 |
| (Polyalkyleneoxide Modified | | |
| Heptamethyltrisiloxane) | | |
| CAS: | a)27306-78-1 | |
| | b) 67674_67-3 | |
| Synperonic PE/L 64-LQ-(CQ) - (Block | | 17.1 |
| copolymer EO/PO) | | |
| Atlox 4913 | | 17.1 |
| (Methyl ether methacrylate copolymer) | | |
| Tween 20-LQ-(CQ) (Polysorbate 20) | | 51.3 |
| Xiameter 1000 ACP | | 17.1 |
| CAS: 102782-80-9 | | |
| Propylene Glycol | | 34.2 |
| CAS: 57-55-6 | | |
| Sodium Acetate | | 1.8 |
| CAS: 127-09-3 | | |
| Acetic Acid | | 9.5 |
| CAS: 64-19-7 | | |
| Proxel GXL | | 0.2 |
| CAS: | a) 2634-33-5 | |
| | b) 1310-73-2 | |

| | |
|---|---|
| AgRH 23 (Xanthan gum) | 2.075 (as 100%) |
| CAS: 11138-66-2 | |
| Water | Up to 1 L (544 g) |

The formulation of Example 1 was prepared by charging water, Silwet L-77, Tween 20, Atlox 4913, Synperonic PE/L64, Propylene Glycol, Xiameter 1000 ACP, Sodium Acetate and Acetic Acid. This was mixed until a homogeneous solution was obtained. Acetic acid was added if needed in order to obtain a pH of 3.8-4.2. First cymoxanil was charged to the premix, followed by fluopicolide. The mixture underwent high shear, until a homogeneous suspension was obtained. During the milling it is crucial to keep the temperature to a maximum of 25° C. The remainder of Tween 20 and Synperonic PE/L64 were added to the milled formulation. Mixing continued until a homogeneous suspension was obtained. Water/AgRH Solution was then added.

### Example 1a—Stability Test:—Fluopicolide+Cymoxanil Suspension Concentrate Composition

The phys-chem parameters of the suspension concentrate obtained in Example 1 were tested according to test methods known to a skilled person. The results are provided in Table 1.

From the results it can be seen that the active ingredient content of samples measured after an accelerated storage stability test, wherein samples were stored for 2 weeks at 54WC, or after storage at temperatures of −10° C. and 0° C. for 2 weeks, remains stable. This indicates that no degradation has taken place. It can be further seen that the particle size of the SC formulation did not undergo any significant change from an initial D90 of 5.16 m to a D90 of 5.6 m after 2 weeks at 54° C.

TABLE 1
Storage stability of the suspension concentrate obtained in Example 1

| | | Room | | | |
|---|---|---|---|---|---|
| | | Temperature | Oven 54° C. | Cold −10° C. | Cold 0° C. |
| Parameter | Initial | 2 weeks | 2 weeks | 2 weeks | 2 weeks |
| Appearance | White | White | White | White | White |
| | suspension | suspension | suspension | suspension | suspension |
| Fluopicolide | 18.6%, | 18.2%, | 18%, | 18.2%, | 18.2%, |
| tech. Conc. | 218 g/L | 209.7 g/L | 207.9 g/L | 222.2 g/L | 209.1 g/L |
| (% w/w, | | | | | |
| g/L) | | | | | |
| Cymoxanil | 21.2%, | 21%, | 20.6%, | 21%, | 21%, |
| tech. Conc. | 248.4 g/L | 241.9 g/L | 237.9 g/L | 256.4 g/L | 241.3 g/L |
| (% w/w, | | | | | |
| g/L) | | | | | |
| PSD D90 | 5.16 | 5.20 | 5.60 | 5.26 | 5.33 |
| (μm) | | | | | |
| pH (Neat), | 3.93 | 3.83 | 4.11 | 3.93 | 3.96 |
| pH (1%) | (19.2° C.), | (20.3° C.), | (19.3° C.), | (19.6° C.), | (20.2° C.), |
| | 4.00 | 4.20 | 4.21 | 4.08 | 4.08 |
| | (20.7° C.) | (21.3° C.) | (21.2° C.) | (21.9° C.) | (21.4° C.) |
| WST 75μ | ok | ok | ok | ok | ok |
| (10%) | | | | | |
| Viscosity | 2210 | 1780 | 1640 | 2300 | 1980 |
| (cP, S63, | | | | | |
| 12 RPM) | | | | | |
| Foaming | 20 | 5 | 4 | 20 | 12 |
| (0.5%) after | | | | | |
| 1 min, ml | | | | | |

### Example 1b—Effect of Antifoam on Particle Size:—Fluopicolide+Cymoxanil Suspension Concentrate Composition

TABLE 2
Effect of antifoam on particle size of the suspension
concentrate obtained in Example 1

| % antifoam (in formulation) | | D90 [μm] after 2 weeks |
|---|---|---|
| added after milling | D90 [μm] at start | at 54 |
| 0 | 4.7 | 6.1 |
| 0.2 | 4.9 | 6.48 |
| 0.5 | 5.75 | 7.58 |

As can be seen in Table 2, the less amount is introduced to the formulation after milling, the smaller the increase in particle size.

It should be noted that in Example 1b, the temperature of the milling was kept at or below 25° C.

### Example 1c—Efficacy of Fluopicolide+Cymoxanil SC Formulation

Potato whole plantlets (var. Bintje) were grown in a 7*7*7 cm pots (8 leaves stage). 4 week old whole plantlet of potato were treated with the fungicide preparations or distilled water (Control) by the aim of a hand-sprayer calibrated at 2 bars in order to deliver 500 L/ha. Three plantlets were treated for each condition tested.

The following treatments were applied:
Control
Presidio® (Fluopicolide 39.5% (479 g.a.i/L)) at a rate of 4 g/ha
Curzate® (Cymoxanil 600 g.a.i/kg) at a rate of 48 g/ha
Cymoxanil+Fluopicolide formulation of Example 1 at a rate of 4.8+4.0 g/ha

After treatment, the potato plantlets were placed under a laminar flow at room temperature until the complete drying of the fungicides or water (control) droplets at the surface of leaves. Twenty-four hours after treatment, plantlets were inoculated on their surface with a hand-sprayer to deliver a calibrated sporangia suspension of Phytophthora infestans. After inoculation, potato plantlets were placed immediately in saturated humidity atmosphere and in a climatic chamber with controlled conditions: 20° C.-14 h day/15° C.-10 h night. Disease assessments were carried out 5 days post inoculation until 15 days post inoculation by evaluating the percentage of disease symptoms, corresponding to potato plantlet symptomatic disease (late blight symptoms).

The Area Under the Disease Progress Curve (AUDPC) is a quantitative measure of disease intensity over time. The efficacy of each formulation tested was determined from the AUDPC value and expressed in percent of the untreated control (water).

The results are presented in Table 3.

TABLE 3
Evaluation of disease severity of preventive treatments by AUDPC

| | Rate | | Efficiency |
|---|---|---|---|
| | (ga.i./ha) | AUDPC | via AUDPC |
| Untreated | Water | 352.7 | |
| Presidio ® | 4.0 | 93.3 | 73.5 |
| (Fluopicolide 39.5% (479 g.a.i/L) | | | |
| Curzate ® | 48.0 | 81.3 | 77.0 |
| (Cymoxanil 600 g.a.i/kg) | | | |
| Example 1 | 4.0 + 4.8 | 0.0 | 100.0 |

TABLE 4
Evaluation of efficiency towards Potato late blight

| | | Efficacy 8 | Efficacy 12 |
|---|---|---|---|
| | Rate | days after | days after |
| | (ga.i./ha) | innoculation | innoculation |
| Untreated | Water | 0 | 0 |
| Presidio ® | 4.0 | 80.9 | 63.2 |
| (Fluopicolide 39.5% | | | |
| (479 g.a.i/L) | | | |
| Curzate ® | 48.0 | 72.3 | 75.8 |
| (Cymoxanil 600 g.a.i/kg) | | | |
| Example 1 | 4.0 + 4.8 | 100 | 100 |

Conclusion—Results clearly show that the treatment with the SC formulation of example 1 is much more potent and effective against Phytophthora infestans than the individual treatments of cymoxanil and fluopicolide. It should be noted that this is the case even though the individual treatment of cymoxanil contains 10 times more cymoxanil than the amount of cymoxanil in the formulation of Example 1.

### Example 2—Fluopicolide+Cymoxanil Suspension Concentrate Composition

| Ingredient | | Concentration (gr/L) |
|---|---|---|
| Fluopicolide Tech (A.I. as 100%) | | 200 |
| CAS: 239110-15-7 | | |
| Cymoxanil tech. (A.I. as 100%) | | 240 |
| CAS: 57966-95-7 | | |
| Silwet L-77 | | 5.7 |
| (Polyalkyleneoxide Modified | | |
| Heptamethyltrisiloxane) | | |
| CAS: | a)27306-78-1 | |
| | b) 67674_67-3 | |
| Synperonic PE/L 64-LQ-(CQ) - (Block | | 17.1 |
| copolymer EO/PO) | | |
| Atlox 4913 | | 17.1 |
| (Methyl ether methacrylate copolymer) | | |
| Tween 20-LQ-(CQ) (Polysorbate 20) | | 51.3 |
| Xiameter 1000 ACP | | 9.5 |
| CAS: 102782-80-9 | | |
| Propylene Glycol | | 34.2 |
| CAS: 57-55-6 | | |
| Sodium Acetate | | 1.8 |
| CAS: 127-09-3 | | |
| Acetic Acid | | 9.5 |
| CAS: 64-19-7 | | |
| Proxel GXL | | 0.2 |
| CAS: | a) 2634-33-5 | |
| | b) 1310-73-2 | |

| | |
|---|---|
| AgRH 23 (Xanthan gum) | 2.075 (as 100%) |
| CAS: 11138-66-2 | |
| Water | Up to 1 L (544 g) |

### Example 2a—Storage Stability of the Suspension Concentrate Obtained in Example 2

| | After 2 weeks | |
|---|---|---|
| | Room temp. | 54° C. |
| Appearance | White suspension | White suspension |
| Fluopicolide Conc. | 210.6 g/L | 208.3 g/L |
| | (18.3%) | (18.1%) |
| Cymoxanil Conc. | 245.1 g/L | 241.7 g/L |
| | (21.3%) | (21.0%) |
| Density, g/ml | 1.1508 | 1.1485 |
| pH (neat) | 3.78 | 3.96 |
| Suspensibility Fluopicolide (0.5%) | 99.73% | 98.52% |
| Suspensibility Cymoxanil (0.5%) | 99.73% | 98.52% |
| Foaming (0.038%) | 0 ml after 1 min | 0 ml after 1 min |
| Foaming (0.5%) | 0 ml after 1 min | 0 ml after 1 min |
| Wet Sieve Residue (10%, 75 μ) | 0.01% | 0.03% |
| Particles size | 5.11 | 5.3 |

### Example 3—Comparative Example

| Ingredient | | Concentration (gr/L) |
|---|---|---|
| Fluopicolide Tech (A.I. as 100%) | | 200 |
| CAS: 239110-15-7 | | |
| Cymoxanil tech. (A.I. as 100%) | | 240 |
| CAS: 57966-95-7 | | |
| Break THRU S-240 | | 5.5 |
| Polyether modified trisiloxane | | |
| CAS: 134180-76-0 | | |
| Silwet L-77 | | 2.2 |
| (Polyalkyleneoxide Modified | | |
| Heptamethyltrisiloxane) | | |
| CAS: | a)27306-78-1 | |
| | b) 67674_67-3 | |
| Tween 20-LQ-(CQ) (Polysorbate 20) | | 49.5 |
| Atlox 4913 | | 16.5 |
| (Methyl ether methacrylate copolymer) | | |
| Synperonic PE/L64 | | 16.5 |
| ethylene oxide/propylene oxide block copolymer | | |
| Rhodorsil 432 | | 14.3 |
| Polydimethylsiloxanes | | |
| Propylene Glycol | | 5.5 |
| CAS: 57-55-6 | | |
| Disodium hydrogen phosphate | | 4.96 |
| CAS: 7558-79-4 | | |
| Citric acid | | 4.96 |
| CAS: 77-92-9 | | |
| AgRH 23 (Xanthan gum) | | 2.5 |
| CAS: 11138-66-2 (as100%) | | |
| Proxel GXL | | 0.25 |
| CAS: | a) 2634-33-5 | |
| | b) 1310-73-2 | |

| | |
|---|---|
| Water | Up to 1 L (~537 g) |

The formulation of Example 3 was prepared by charging water, Break THRU 5-240, Silwet L-77, Tween 20, Atlox 4913, Synperonic PE/L64, Propylene Glycol, Rhodorsil 432, Disodium hydrogen phosphate and Citric acid. This was mixed until a homogeneous solution was obtained. Add citric acid if needed in order to obtain a pH of 4. First cymoxanil was charged to the premix, followed by fluopicolide. The mixture underwent high shear, until a homogeneous suspension was obtained. During the milling the temperature was kept at approximately 17° C. The remainder of Tween 20 and Synperonic PE/L64 and Rhodorsil 432 were added to the milled formulation. Mixing continued until a homogeneous suspension was obtained. Water/AgRH solution was then added.

### Example 3a—Stability Test

The phys-chem parameters of the suspension concentrate obtained in Example 3 were tested according to test methods known to a skilled person. The results are provided in Table 5.

TABLE 5
Storage stability of the suspension concentrate obtained in Example 3

| | | Room | | |
|---|---|---|---|---|
| | | Temperature | Oven 54° C. | Oven 54° C. |
| Parameter | Initial | 2 weeks | 4 days | 2 weeks |
| Appearance | White | White | White | White |
| | suspension | suspension | suspension | suspension |
| PSD D90 | 4.95, | 4.86 | 5.93, | 5.26 |
| (μm) | (D100 = 205) | | (D100 = 441) | |
| pH (Neat), pH | 4.18 (20.4° C.), | 4.29 (21.8° C.), | 5.26 (21.6° C.), | |
| (1%) | 4.67 (18.1° C.) | 4.75 (20.6° C.) | 5.55 (20.5° C.) | |
| Viscosity (cP, | 1760 | | 1480 | |
| S63, 12 RPM) | | | | |
| Foaming | 70 ml | 50 ml | 30 ml | |
| (0.5% v/v) | | | | |
| After 1 min | | | | |

After the storage stability test of 2 weeks 54° C. large crystals were observed.

As can be seen in Table 6, the buffer system used in Example 3 does not work in keeping the pH level of the formulation stable. After only 4 days at 54° C. the pH of the formulation of Example 2 increases from 4.18 to 5.26. As indicated above, as the pH rises, cymoxanil starts to degrade rapidly.

While the present invention has been shown and described with reference to preferred embodiments thereof, it will be understood by those skilled in the art that many alternatives, modifications and variations may be made thereto without departing from the spirit and scope thereof. Accordingly, it is intended to embrace all such alternatives, modifications, and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

In addition, any priority document(s) of this application are hereby incorporated herein by reference in their entirety.

1. A stable suspension concentrate (SC) composition comprising:
a) cymoxanil;
b) a buffering system;
c) optionally at least one additional pesticide; and
d) optionally an agriculturally acceptable carrier;
wherein the buffering system has an effective pH range of 2-5.

2. The composition of claim 1, wherein the buffering system comprises a conjugate acid-base pair selected from the group comprising acetic acid/sodium acetate and formic acid/potassium formate.

3. The composition of claim 1, wherein the composition has low persistent foam.

4. The composition of claim 1, wherein the amount of cymoxanil in the composition is from about 0.1% to about 50% by weight, based on the total weight on the composition.

5. The composition of claim 1, wherein the amount of the buffering system in the composition is about 0.1% to about 5% by weight, based on the total weight on the composition.

6. The composition of claim 1, wherein the ratio between the cymoxanil and the buffering system is at least 1:30.

7. The composition of claim 1, wherein the composition comprises an amount of at least one additive.

8. The composition of claim 7, wherein the at least one additive is selected from the group consisting of adjuvants, surfactants, emulsifiers, antifreeze agents, an antifoam agents, solvents, co-solvents and preservatives.

9. The composition of claim 7, wherein the at least one additive is in an amount in the composition from about 1% to about 80% by weight, based on the total weight of the composition.

10. The composition of claim 1 comprising the agriculturally acceptable carrier and the agriculturally acceptable carrier is in an amount in the composition of about 0.1% to about 90% by weight, based on the total weight on the composition.

11. The composition of claim 1 comprising the at least one additional pesticide and wherein the at least one additional pesticide is stable in a low pH environment (pH=2-5).

12. The composition of claim 1 comprising the at least one additional pesticide and wherein the at least one additional pesticide is selected from the group consisting of fluopicolide, fluopyram, fluopimomide, tioxymid, trichlamide, zarilamid and zoxamide.

13. The composition of claim 12, wherein the at least one additional pesticide is fluopicolide.

14. The composition of claim 1, wherein the composition comprises:
about 18-25% by weight of cymoxanil, based on the total weight of the composition,
about 15-20% by weight of fluopicolide, based on the total weight of the composition,
about 0.5-2% by weight of the buffering system, based on the total weight of the composition,
about 10-15% by weight of additives, based on the total weight of the composition, and
about 45-55% by weight of an agriculturally acceptable carrier, based on the total weight of the composition.

15. A process for preparing a stable suspension concentrate composition comprising:
a) obtaining an amount of cymoxanil and a buffering system; and
b) milling the cymoxanil and the buffering system at a temperature of at most 25° C.;
wherein the buffering system has an effective pH range of 2-5.

16. The process of claim 15, further comprising the addition of an antifoaming agent before the milling step.

17. The process of claim 15, further comprising the addition of an antifoaming agent after the milling step.

18. The process of claim 15, wherein crystal growth of cymoxanil is controlled.

19. The process according to claim 15, wherein the buffering system comprises a conjugate acid-base pair selected from the group comprising acetic acid/sodium acetate and formic acid/potassium formate.

20. The process of claim 15, wherein minimal or no foam is produced.

21. The process of claim 15, wherein the cymoxanil is in an amount in the composition from about 0.1% to about 50% by weight, based on the total weight on the composition.

22. The process of claim 15, wherein the buffering system is in an amount in the composition of about 0.1% to about 5% by weight, based on the total weight on the composition.

23. The process of claim 15, further comprising adding at least one additive.

24. The process of claim 23, wherein the at least one additive is selected from the group consisting of of adjuvants, surfactants, emulsifiers, antifreeze agents, an antifoam agents, solvents, co-solvents and preservatives.

25. The process of claim 23, wherein the at least one additive is in an amount in the composition from about 1% to about 80% by weight, based on the total weight of the composition.

26. The process of claim 15, further comprising adding an agriculturally acceptable carrier wherein the agriculturally acceptable carrier is in an amount in the composition of about 0.1% to about 90% by weight, based on the total weight on the composition.

27. The process of claim 15, further comprising adding an additional pesticide.

28. The process of claim 27, wherein the additional pesticide is stable in a low pH environment (pH=2-5).

29. The process of claim 27, wherein the additional pesticide is selected from the group consisting of fluopicolide, fluopyram, fluopimomide, tioxymid, trichlamide, zarilamid and zoxamide.

30. The process of claim 29, wherein the additional pesticide is fluopicolide.

31. A stable suspension concentrate (SC) composition prepared according to the process of claim 15.

32. A method of controlling and/or preventing pests comprising applying an effective amount of the SC composition of claim 1 to a locus where the pest is to be controlled and/or prevented so as to thereby control and/or prevent the pest.

33. The method of claim 32, wherein the locus is a crop selected from the group consisting of grapes, potato, cocoa, palm oil, tomato, pepper, cucumber, melon, cauliflower, cabbage, onion, garlic, lettuce and roses.

34. The method of claim 32, wherein the the applying an effective amount of the SC composition is applying the SC composition at an amount from about 0.1 L/ha to about 2 L/ha.

35. The method of claim 34, wherein the the amount is from about 0.5 L/ha to about 0.7 L/ha.

36. The method of claim 32, wherein the the applying an effective amount of the SC composition is applying the SC composition at an amount from about 50 g/ha of cymoxanil to about 250 g/ha of cymoxanil.

37. The method of claim 36, wherein the amount is from about 100 g/ha of cymoxanil to about 200 g/ha of cymoxanil.

38. (canceled)

39. A method of treating a locus against pest infestation comprising applying an effective amount of the composition of claim 1 to the locus so as to thereby treat the locus against pest infestation.

40. A method for treating a plant or a plant material against pest infestation comprising applying an effective amount of the composition of claim 1 to the plant, the plant material, or the vicinity of the plant or plant material so as to thereby treat the plant or plant material against pest infestation.

41. A method for controlling and/or preventing of fungal attack on soil, plant, tuber, fruit, root, foliage, seed, locus of the fungus, or a locus where fungal infestation is to be prevented, wherein the method comprises applying a fungicidally effective amount of the composition of claim 1 to the soil, plant, tuber, fruit, roots, foliage, seed, locus of the fungus, or locus in which the infestation is to be prevented so as to thereby control and/or prevent fungal attack.
